(19) United States
(12) Patent Application Publication
(10) Pub. No.: US 2017/0164140 A1
(43) Pub. Date: Jun. 8, 2017

(54) METHOD AND DEVICE FOR SELECTING TARGET DEVICE

(71) Applicant: MediaTek Singapore Pte. Ltd., Singapore (SG)

(72) Inventors: YAJUN LI, Beijing (CN); Yanni HUANG, Beijing (CN); Dan LUO, Shaoshan (CN); Meng LI, Beijing (CN)

(21) Appl. No.: 15/138,621

(22) Filed: Apr. 26, 2016

(30) Foreign Application Priority Data
Dec. 2, 2015 (CN) 201510872274.4

(51) Int. Cl. H04W 4/00; H04W 8/00

(52) U.S. Cl. CPC H04W 4/008; H04W 8/005; H04W 92/18

(57) ABSTRACT

The present invention discloses a method for selecting at least one target device, and the method is applied to a main electronic device for selecting at least one slave electronic device as the target device. The method includes obtaining the main-device-location information of the main electronic device and the slave-device-location information of the slave electronic devices; determining the orientation of the main electronic device; calculating relative location information for each slave electronic device corresponding to the main electronic device based on the main-device-location information and the slave-device-location information; determining whether there are any slave electronic devices in the direction of a first baseline according to the relative location information, wherein the direction of the first baseline is the orientation of the main electronic device; and selecting at least one slave electronic device as the target device when the slave electronic device exists in the direction of the first baseline.

### CROSS REFERENCE TO RELATED APPLICATION

The present application is based on, and claims priority of, China Application Number 201510872274.4, filed on Dec. 2, 2015, the invention of which is hereby incorporated by reference herein in its entirety.

### TECHNICAL FIELD

The present invention relates to a method of selecting a target device, and in particular to a method and electronic device for selecting at least one target device.

### BACKGROUND

According to existed wireless sharing methods, before a user selects a target device with which to share relevant data (such as pictures, data or video, etc.), the user needs to click a button on a main electronic device or enable an application program (such as Bluetooth) on the main electronic device, and then search for nearby slave electronic devices. After the search for a specific slave electronic device is complete, the user may click the specific slave electronic device on the main electronic device to set that specific slave electronic device as the target device, thus completing the selection of the target device with which the main electronic device will share. On the other hand, when selecting the sharing target on the main electronic device, the user needs to wait until the target responds with feedback, and then the main electronic device can share relevant data with the target device. Although the operation mentioned above can perform the function of sharing relevant data, it still has some disadvantages, such as both sides requiring the same software capability (both sides should have the Bluetooth function enabled, for example), and both sides should perform the search steps corresponding to each other to select the target, so as to share relevant data. The entire operation described above is complicated and difficult, and it can also easily lead to a negative user experience.

### SUMMARY

The present invention provides a method and electronic device for selecting at least one target device, and can select at least one target device in a quick, simple, and easy way.

The present invention provides a method of selecting at least one target device, and the method is applied to a main electronic device for selecting, from slave electronic devices connected to the main electronic device, at least one slave electronic device as the target device. The method comprises obtaining main-device-location information for the main electronic device and slave-device-location information for the slave electronic devices, determining the orientation of the main electronic device, calculating, based on the main-device-location information and the slave-device-location information, relative location information for each slave electronic device corresponding to the main electronic device, determining whether there is at least one slave electronic device in the direction of a first baseline according to the relative location information, wherein the direction of the first baseline is the orientation of the main electronic device, and selecting at least one slave electronic device as the target device when the at least one slave electronic device exists in the direction of the first baseline.

The present invention also provides an electronic device. The electronic device connects slave electronic devices and supports a method for selecting at least one target device. The electronic device comprises a transceiver module, a locating module, an orientation module, and a processor. The transceiver module obtains the slave-device-location information of the slave electronic devices. The locating module obtains the main-device-location information of the electronic device through location technology. The orientation module determines the orientation of the electronic device. The processor is coupled to the transceiver module, locating module, and orientation module. The processor calculates relative location information for each slave electronic device corresponding to the electronic device based on the main-device-location information and the slave-device-location information. The processor determines whether there is at least one slave electronic device in the direction of a first baseline according to the relative location information, wherein the direction of the first baseline is the orientation of the electronic device. The processor selects at least one slave electronic device as the target device when the at least one slave electronic device exists in the direction of the first baseline.

The present invention also provides an electronic device, and the electronic device is connected to a main electronic device. The electronic device comprises a transceiver module and a locating module. The transceiver module receives a query instruction from the main electronic device. The locating module generates location information for the electronic device through location technology. The transceiver module further shares the location information of the electronic device to the main electronic device, which makes the main electronic device select at least one electronic device connected to the main electronic device as at least one target device according to the location information of the at least one electronic device and second location information of the main electronic device.

The present invention is different from the technique used in the prior art. Based on the method described herein, the present invention can quickly select at least one target device by only aligning the direction of the main electronic device with at least one slave electronic device. Based on the described method, the present invention can quickly select at least one target device, operate in a simple and easy way, and greatly improve user experience.

### BRIEF DESCRIPTION OF THE DRAWINGS

The present disclosure can be more fully understood by reading the subsequent detailed description and examples with references made to the accompanying drawings, wherein:

FIG. 1 shows a flow chart of a method for selecting a target device according to an embodiment of the present disclosure.

FIG. 2 shows a schematic diagram of the connection between a main electronic device and slave electronic devices according to an embodiment of the present disclosure.

FIG. 3A-3B show a flow chart of a method for selecting a target device according to another embodiment of the present disclosure.

FIG. 4 shows a schematic diagram of the connection between a main electronic device and slave electronic devices according to another embodiment of the present disclosure.

FIG. 5A-5B show a flow chart of a method for selecting a target device according to another embodiment of the present disclosure.

FIG. 6 shows a schematic diagram of the connection between a main electronic device and slave electronic devices according to another embodiment of the present disclosure.

FIG. 7 shows a schematic diagram of the connection between a main electronic device and slave electronic devices according to another embodiment of the present disclosure.

FIG. 8 shows a schematic diagram of a wireless network environment according to an embodiment of the present disclosure.

FIG. 9 shows a schematic diagram of a main electronic device module according to an embodiment of the present disclosure.

FIG. 10 shows a schematic diagram of a slave electronic device module according to an embodiment of the present disclosure.

### DETAILED DESCRIPTION

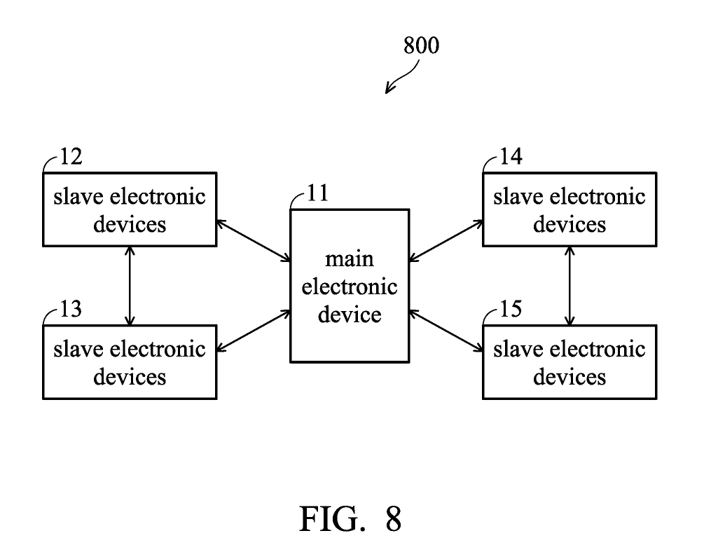

FIG. 8 shows a schematic diagram of a wireless network environment 800 according to an embodiment of the present disclosure. The wireless network environment 800 includes a main electronic device 11 and at least one slave electronic device (slave electronic devices 12-15). The main electronic device 11 wirelessly connects to the slave electronic devices 12-15, and the wireless connection can be the Bluetooth, Wi-Fi or any wireless connection utilized in the art. In one embodiment, the main electronic device can be a cellphone, and the slave electronic device can be a tablet or a sports wristband. In another embodiment, the main electronic device can be a remote controller, and the slave electronic device can be an air conditioner, a refrigerator, a television, a chandelier, or another smart home appliance. The present invention is not limited to the above description.

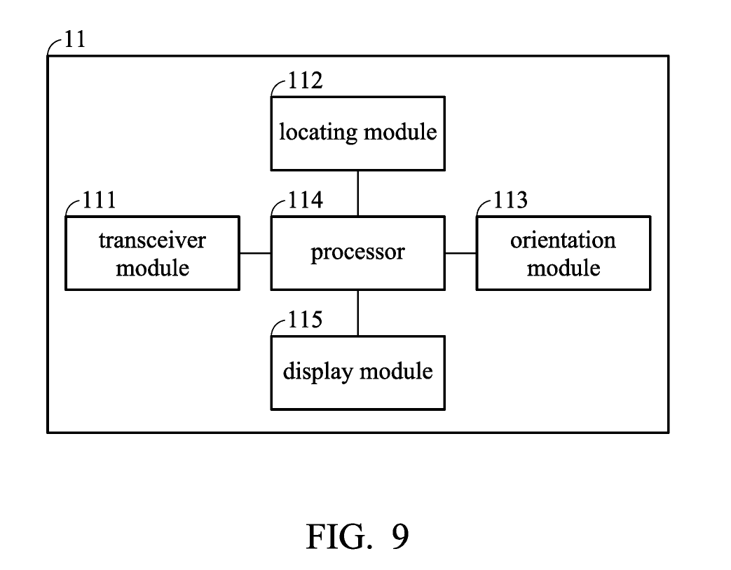

FIG. 9 shows a schematic diagram of a main electronic device module according to an embodiment of the present disclosure. As shown in FIG. 9, the main electronic device 11 includes a transceiver module 111, a locating module 112, an orientation module 113, a processor 114 and a display module 115.

The transceiver module 111 can transmit a query instruction to each slave electronic device to require location information of each slave electronic device, and receive the location information from each slave electronic device.

The locating module 112 can obtain the location information of the main electronic device 11. In this embodiment, the locating module 112 can be a location element, for locating the position of the main electronic device 11 using a GPS technique or the like.

The orientation module 113 can determine the orientation of the main electronic device 11, and the orientation module 113 can include a compass, an acceleration sensor, or a gravity sensor, etc. In one embodiment, when the user rotates the main electronic device 11 in order to align it with at least one slave electronic device that is expected to serve as at least one target device, the orientation module 113 of the main electronic device 11 can acquire the horizontal deflection angle and the pitch angle of the main electronic device by calculating its own direction, acceleration, and so forth, and then obtain the orientation of the main electronic device. In another embodiment, the orientation of the main electronic device can be the specific direction of a signal transmitted by the transmitter of the main electronic device.

The processor 114 is coupled to the transceiver module 111, locating module 112, and orientation module 113. The processor 114 can be a general-purpose processor or a micro-control unit (MCU), etc. The processor 114 can control the operations of the transceiver module 111, locating module 112, orientation module 113, and other devices. The processor 114 can further include a plurality of logic processors to provide the method of selecting at least one target device from the slave electronic devices described herein. The processor 114 can calculate the relative location information of the slave electronic devices 12-15 corresponding to the main electronic device 11 according to the location information of the main electronic device 11 and slave electronic devices 12-15. Specifically, the processor 114 can calculate the horizontal deflection angle and pitch angle of the main electronic device 11, and can also calculate the relative deflection angle of the slave electronic devices 12-15. The processor 114 can further determine whether there are any slave electronic devices in the direction of a first baseline, wherein the direction of the first baseline is the orientation of the main electronic device 11. Considering the error, the processor 114 also can determine whether there are any slave electronic devices in a predetermined space whose central line is the first baseline line. In one embodiment, the predetermined space may be the space using the first baseline as its own central line and having a 45-degree expansion angle, and moreover, the predetermined space may be modified to have an expansion angle of 0-90 degrees, but the present invention is not limited to the above description. The smaller the expansion angle is set, the more accurate the operation of the orientation rotation that is required. Conversely, enlarging the expansion angle will make the orientation rotation require less accuracy. It is not only the predetermined space that may serve as the selecting limitation, but the physical space in which the device exists may also be one of the selecting limitations, including being outside the predetermined space (in the next room), experiencing signal degradation, or determining that the positions are not in the same room according to an indoor map. Any device hampered by one of the limitations mentioned above will not be selected for calculation, even if the device is in the space having a 45-degree expansion angle.

For enlarging the selection range, the processor 114 can further determine whether any slave electronic devices exist in a second predetermined space in the direction of a second baseline. In this case, the second baseline is a line which connects the main electronic device 11 and a first slave electronic device, wherein the first slave electronic device is the closest one to the orientation of the main electronic device 11. The first slave electronic device has the smallest angle and shortest distance between the main electronic device 11.

The processor 114 can further select at least one slave electronic device (slave electronic device 12, for example) as at least one target device when the processor 114 determines the at least one slave electronic device exists in the direction of the first baseline, predetermined space using the first baseline as its own central line, or second predetermine space using the second baseline as its own central line.

The display module 115 displays one or more target devices to the user for checking, or further for selecting at least one slave electronic device, which is selected as the target device, to perform a control operation. In one embodiment, the main electronic device 11 may send data to at least one slave electronic device selected as at least one target device.

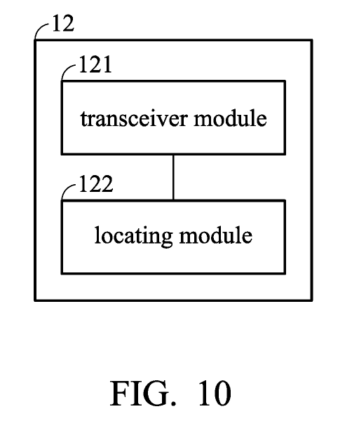

FIG. 10 shows a schematic diagram of a slave electronic device module according to an embodiment of the present disclosure. As shown in FIG. 10, the slave electronic device 12 includes a transceiver module 121 and a locating module 122.

The transceiver module 121 may be used to receive the query instruction from the main electronic device 11 communicatively connected to the slave electronic device 12, moreover, the transceiver module 121 may also be used to send its own location information to the main electronic device 11. The locating module 122 may be used to determine the location of the slave electronic device 12 using the location technique after the transceiver module 121 obtains the query instruction from the main electronic device 11.

In one embodiment, the transceiver module 121 may also be used to reply to the main electronic device 11 with a confirmation instruction after the main electronic device 11 selects the slave electronic device 12 as the target device, which confirms the slave electronic device 12 is the target device of the main electronic device 11. After the main electronic device 11 has confirmed the target device, the transceiver module 121 may also be used to receive the relevant data transmitted by the main electronic device 11, such as pictures, video, information, or other data.

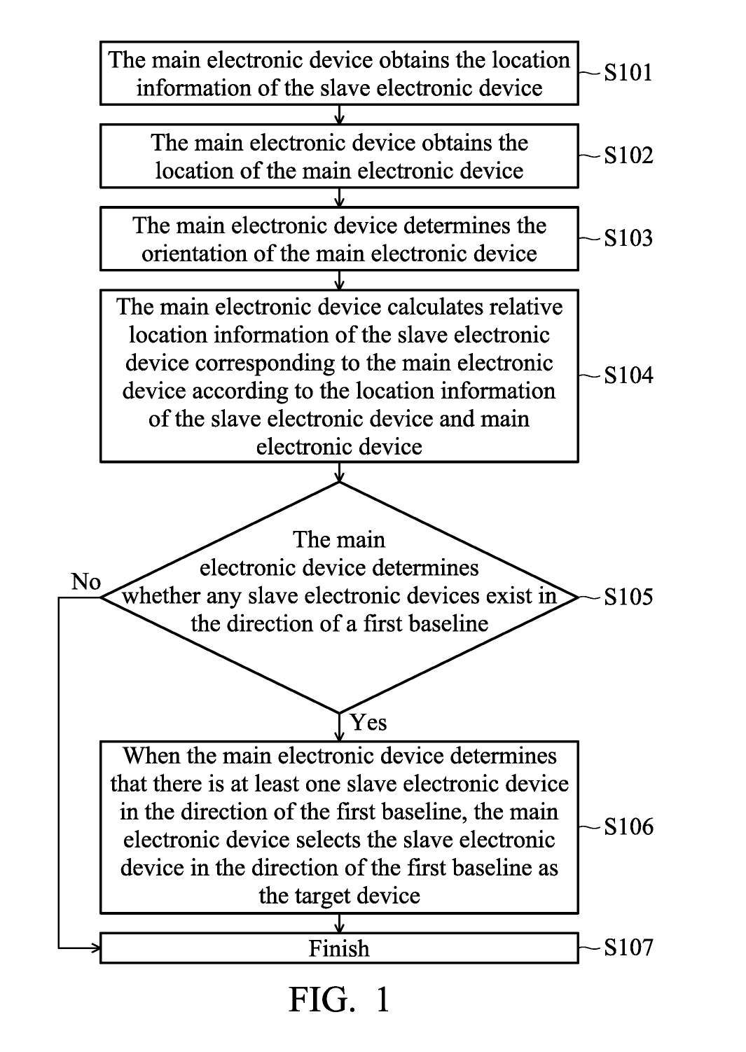

FIG. 1 shows a flow chart of a method 100 for selecting a target device according to an embodiment of the present disclosure. The method 100 can be performed by the main electronic device 11 shown in FIG. 8, wherein the slave electronic devices 12-15 may be used as the slave electronic devices in this case. The method 100 comprises the following steps.

In step S101, the main electronic device obtains the location information of at least one slave electronic device through a transceiver module, wherein the main electronic device wirelessly connects to at least one slave electronic device. In the beginning, the main electronic device sends a query instruction to at least one slave electronic device through the transceiver module, and then receives the location information of each slave electronic device by the transceiver module. On the other hand, each slave electronic device obtains its own location information through its own locating module after receiving the query instruction, and sends the location information to the main electronic device respectively in order to share the location information with the main electronic device. The locating module may apply various location techniques to obtain the location information of the slave electronic device in which the locating module is provided. The location information may be the information of the city, street, latitude, longitude, coordinate point and so forth. Regarding the location techniques obtaining the location information, since there are lots of existed related techniques, they will not be discussed herein.

In some embodiments, the main electronic device sends a query instruction to a server through the transceiver module, wherein the server is communicatively connected to the main electronic device, and receives the location information of at least one slave electronic device connected to the server from the server. In these embodiments, the server stores various location information of various slave electronic devices connected to itself, or the server transmits the query instruction to the various slave electronic devices. After the slave electronic device obtains the query instruction sent by the main electronic device, the slave electronic device obtains the location of the slave electronic device through the location technique and sends the location information of the slave electronic device to the server after obtaining the query instruction sent from the main electronic device.

In step S102, the main electronic device obtains the location of the main electronic device by a locating module. The locating module may apply various location techniques to obtain the location information of the main electronic device, and the location information may be the information of the city, street, latitude, longitude, coordinate point and so forth. Since there are lots of existed techniques related to the location techniques, and they will not be discussed herein.

In step S103, the main electronic device determines the orientation of the main electronic device by an orientation module.

In step S104, a processor of the main electronic device calculates relative location information of at least one slave electronic device corresponding to the main electronic device according to the location information of at least one slave electronic device and main electronic device.

Specifically, the location information of at least one slave electronic device obtained by the main electronic device may include the location coordinate of at least one slave electronic device, and the location information of the main electronic device may include the location coordinate of the main electronic device. Therefore, the processor of the main electronic device can acquire the relative positions corresponding to the main electronic device and at least one slave electronic device based on the location information. For example, the deflection angle between at least one slave electronic device and the orientation of the main electronic device.

In step S105, the processor of the main electronic device determines whether at least one slave electronic device exists in the direction of a first baseline. If there is at least one slave electronic device in the direction of the first baseline, the flow goes to step S106, otherwise, the flow goes to step S107.

In this embodiment, the direction of the first baseline is the orientation of the main electronic device. In other embodiments, the first baseline may be a wave line, curve lines, or a half cycle.

In step S106, when there is at least one slave electronic device in the direction of the first baseline, the processor determines that the at least one slave electronic device in the direction of the first baseline will serve as the at least one target device. In other embodiments, the main electronic device may further display, on a display module, the at least one slave electronic device, which is in the direction of the first baseline, to the user for further selecting at least one required target device from the at least one slave electronic device to perform an operation(such as control operation). Considering the error of the above operations, the main electronic device can also determine whether any slave electronic devices exist in the region near to the direction of the first baseline, that is, it determines whether any slave electronic devices exist in the region having a predetermined distance between the first baseline. The distance between the main electronic device and the slave electronic device is restricted in a predetermined range, and if the distance is greater than the predetermined range, the main electronic device is unable to detect the slave electronic device.

In step S107, the search and selection of at least one target device are finished.

It should be understood by those skilled in the art that the steps described above can be modified, omitted or rearranged without departing from the spirit of the present invention. In one embodiment, the step S102 can be performed before the step S101. In one embodiment, the step S104 can be performed before the step S103. The feature of the present invention is to determine whether any slave electronic devices exist in the direction pointed by a main device according to the location information of the main and slave electronic device and the orientation information of the main device, which enables the slave electronic device can quickly be selected as a target device, and the main device can directly send instructions, data and so forth to the target device. A method or step that satisfies the spirit of what is described above is within the scope of the present invention.

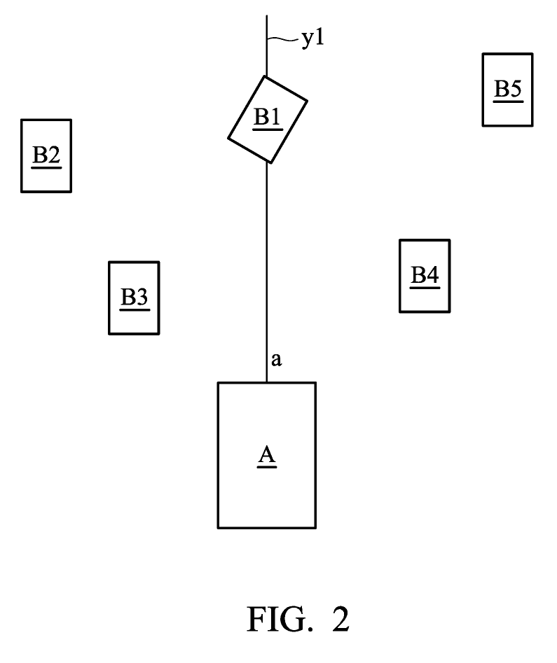

FIG. 2 shows a schematic diagram of the connection between a main electronic device A and slave electronic devices B1-B5 according to an embodiment of the present disclosure. As shown in FIG. 2, only the slave electronic device B1 exists in a direction of a first baseline y1 of the main electronic device A, and the slave electronic device B1 located in the direction of the first baseline yl is selected as a target device.

In this embodiment, after the main electronic device A selects the target device, the main electronic device A can perform a control operation to the target device, such as sending data, etc. It should be understood, since the slave electronic device B1 is the only one device existed in a predetermined space “a”, which is in the direction of the first baseline yl of the main electronic device A, the main electronic device A can directly perform control operation to the target device without waiting for the confirmation information responded by the slave electronic device B1 after the main electronic device A selects the slave electronic device B1. That is, the control instruction of the main electronic device A directly operates on the slave electronic device B1 located in the predetermined space “a” in the direction of the first baseline y1 without any other additional operations, which greatly improves the efficiency and user experience of the operation (sharing data).

In other embodiments, considering the error, the main electronic device can further expand the selection range to the predetermined space using the direction of the first baseline as the central line thereof

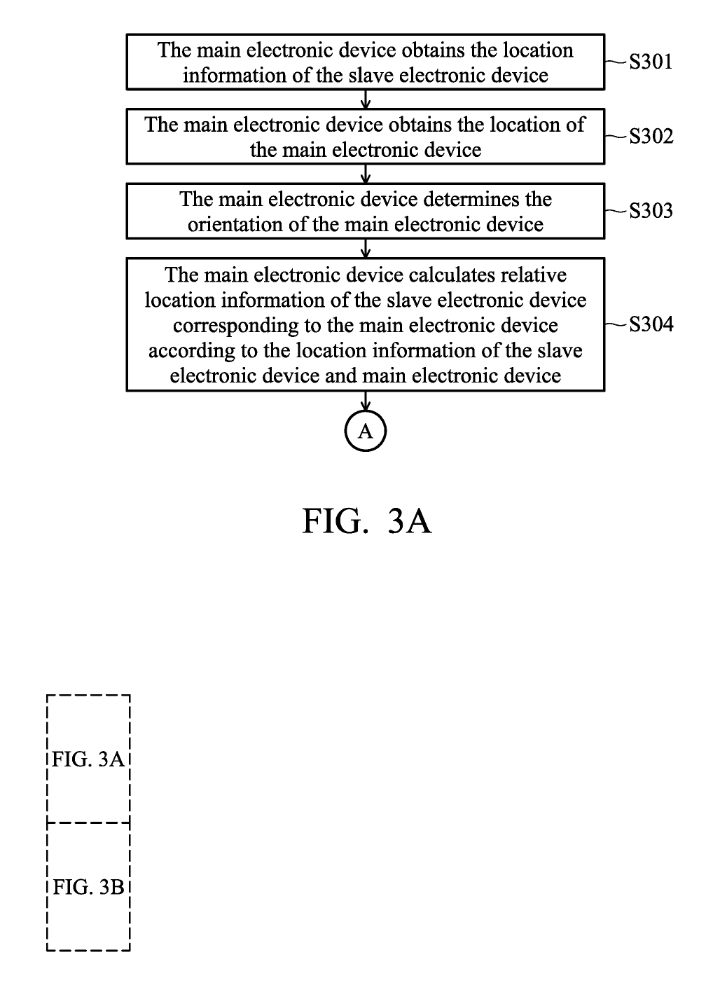

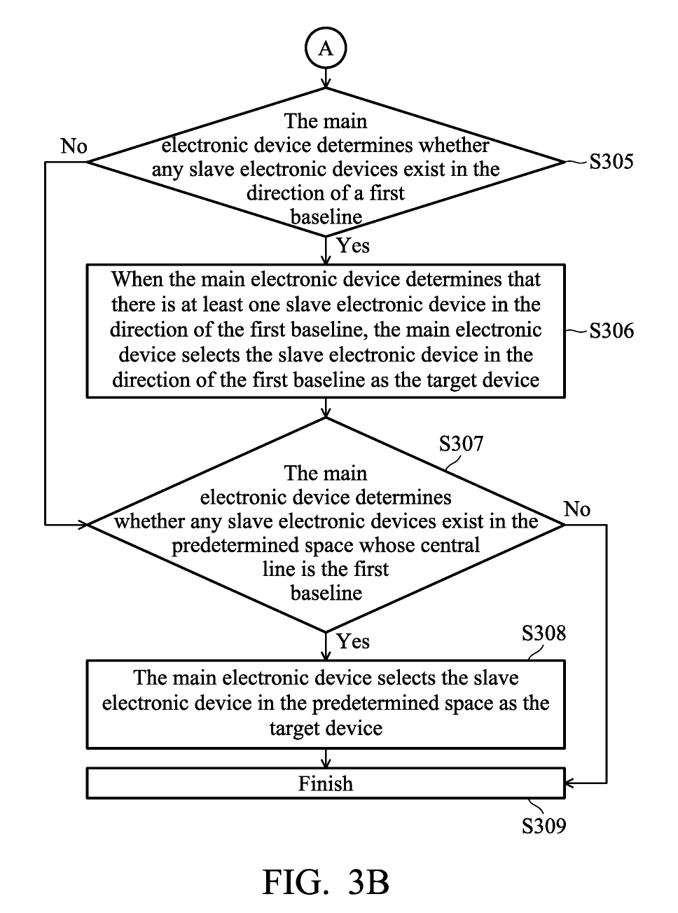

FIG. 3 shows a flow chart of a method 300 of selecting at least one target device according to another embodiment of the present disclosure. Since the steps S301-S304 of the method 300 are the same steps as the steps S101-S104 of the method 100, the descriptions of the steps S301-S304 are omitted for brevity. The differences between the method 300 and method 100 are indicated below. A processor of a main electronic device determines whether any slave electronic devices exist in the direction of a first baseline. When no slave electronic devices exist in the direction of the first baseline, the method 300 further determines whether any slave electronic devices exist in a predetermined space using the direction of the first baseline as the central line thereof. The specific description follows.

In step S305, the processor of the main electronic device determines whether any slave electronic devices exist in the direction of the first baseline. If there is at least one slave electronic device, the flow goes to step S306, otherwise, the flow goes to step S307.

In step S306, if the main electronic device determines that there is at least one slave electronic device in the direction of the first baseline, the main electronic device selects the at least one slave electronic device in the direction of the first baseline as the at least one target device. In other embodiments, the main electronic device may further display, on a display module, the at least one slave electronic device to the user for further selecting at least one required target device from the at least one slave electronic device to perform an operation(such as control operation).

In step S307, when the main electronic device determines that there is no slave electronic device existed in the direction of the first baseline, the main electronic device determines whether any slave electronic devices exist in the predetermined space using the direction of the first baseline as the central line thereof If there is at least one slave electronic device in the predetermined space, the flow goes to step S308, otherwise, the flow goes to step S309.

In an embodiment, the main electronic device determines whether any slave electronic devices exist in the space which uses the direction of the first baseline as its own central line and has a 45 degree expansion angle. The size of the predetermined space is decided by multiple factors, and the factors include the supporting range of the main electronic device, setting of the search range, and the number and density of the slave electronic devices connected to the main electronic device, etc. Moreover, in other embodiments, the size of the predetermined space is also determined based on the remaining power of the main electronic device. The more power that remains in the main electronic device, the larger the predetermined space is set. The less power that remains in the main electronic device, the smaller the predetermined space is set, in order to save power. Furthermore, the expansion angle “a” of the predetermined space can be set by the user of the main electronic device, wherein the range of the expansion angle may be from 0 to 90 degrees. The smaller the expansion angle is set, the more accurate the operation of the orientation rotation that is required. Conversely, enlarging the expansion angle will make the orientation rotation require less accurate. In addition to determining whether any slave electronic devices exist in the predetermined space in the direction of the first baseline, the main electronic device can also determine whether any slave electronic devices exist in predetermined planes (horizontal range and vertical range) in the direction of the first baseline. When the main electronic device determines whether any slave electronic devices exist in the predetermined space in the direction of the first baseline, the main electronic device also filters other slave electronic devices. For example, the main electronic device performs filtering to the physical space in which other slave electronic devices exist, wherein the slave electronic device will be filtered out and will not be the target determined by the main electronic device when the slave electronic device experiences signal degradation, or when the slave electronic device is determined to be located in a different room according to an indoor map, for example.

In step S308, when the main electronic device determines that there is at least one slave electronic device in the predetermined space using the direction of the first baseline as the central line thereof, the main electronic device selects the at least one slave electronic device in the predetermined space as at least one target device. In other embodiments, the main electronic device displays, on a display module, at least one slave electronic device in the predetermined space using the direction of the first baseline as its own central line to the user of the main electronic device, which is for the user to select a part of (such as one, part of, or all of) the at least one slave electronic device in the predetermined space using the direction of the first baseline as its own central line as at least one target device, and then the main electronic device can perform the controlling or data transmission in the following steps.

In step S309, the search and selection of at least one target device are finished.

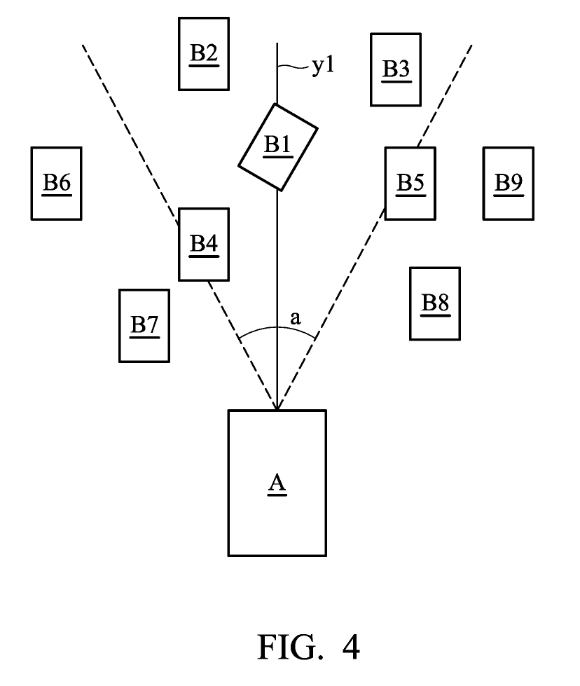

FIG. 4 shows a schematic diagram of the connection between a main electronic device A and slave electronic devices B1-B9 according to another embodiment of the present disclosure. As shown in FIG. 4, when the slave electronic devices B1-B5 exist in a predetermined space “a” whose central line is the direction of the first baseline yl, the slave electronic devices are selected as target devices. Moreover, a display module of the main electronic device A may display the slave electronic devices B1-B5 to the user for further selecting the required target device, and the user can select the target device according to actual need. For example, when the slave electronic devices B1-B5 exist in the predetermined space whose central line is the direction of the first baseline yl, the main electronic device A informs the user through the menu or voice report according to the distance or device type (such as the slave electronic devices B1-B5 belong to the stranger, friend, colleague, or family and so forth respectively recorded by the main electronic device A) of the slave electronic devices B1-B5 to provide selections to the user, and the operation (sharing) described above is more accurate than in the prior art.

Furthermore, in other embodiments, if the main electronic device determines that there is no slave electronic device existed in the direction of the first baseline and the predetermined space using the direction of the first baseline as its own central line, the main electronic device still can determine the slave electronic device which is closest to the orientation of the main electronic device, and make a line connecting the main electronic device and the slave electronic device, which is closest to the orientation of the main electronic device, to be a second baseline. The main electronic device may expand the selection range through searching the target device on the second baseline.

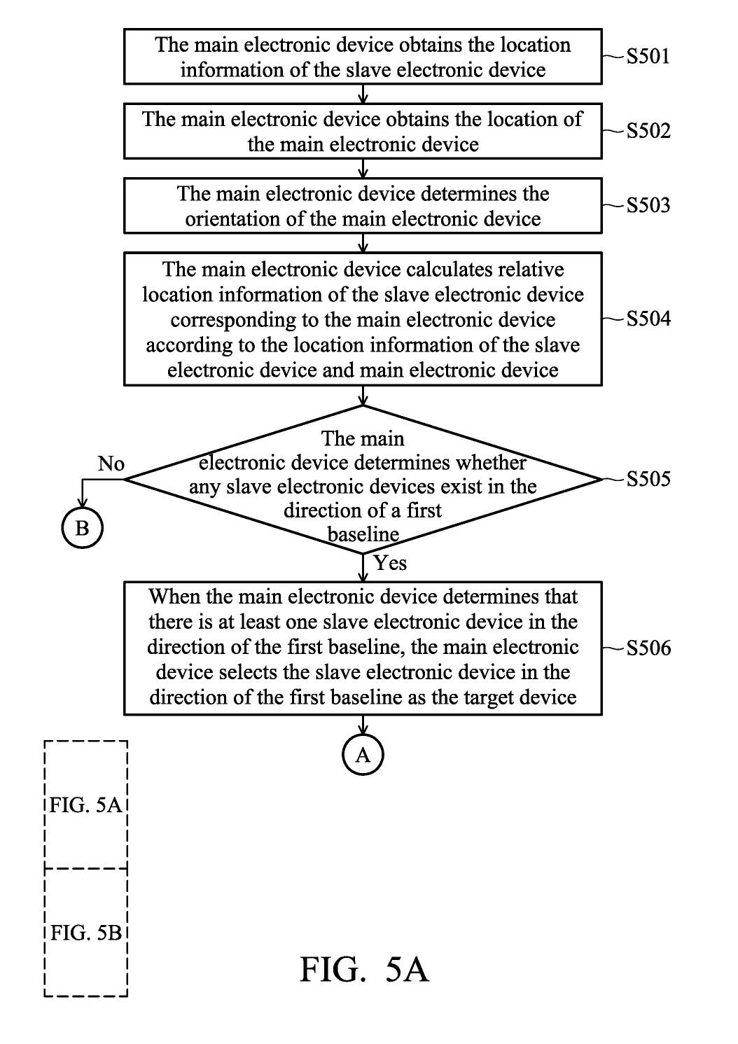

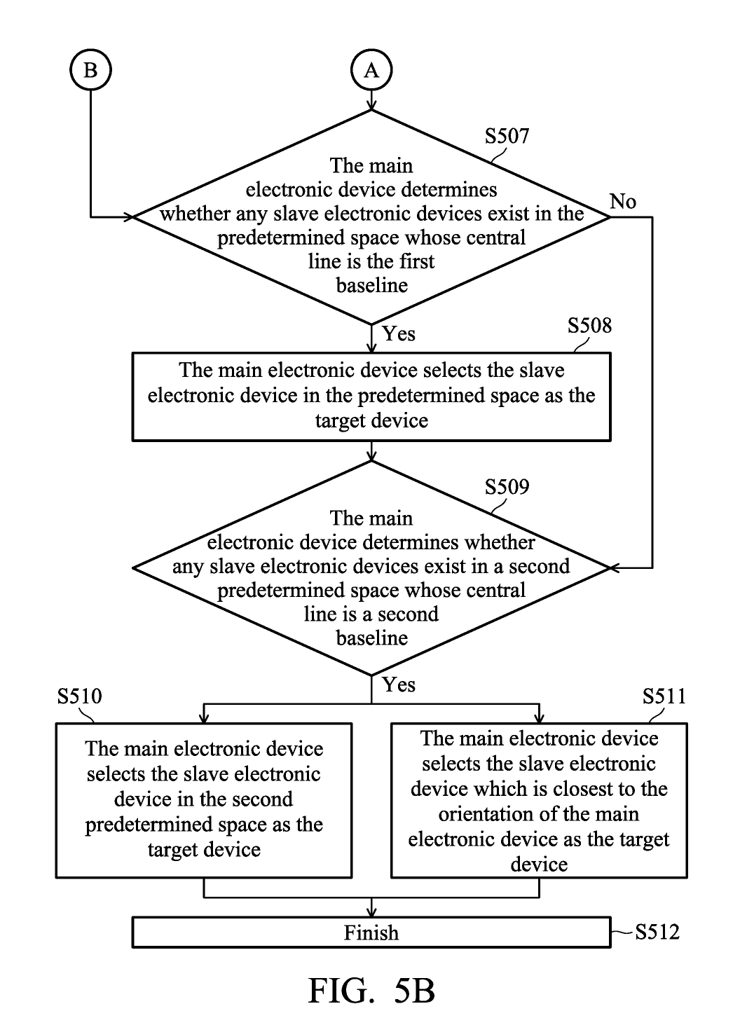

FIG. 5 shows a flow chart of a method 500 of selecting at least one target device according to another embodiment of the present disclosure. Since the steps S501-S506 of the method 500 are the same steps as the steps S301-S306 of the method 300, the descriptions of the steps S501-S506 are omitted for brevity. The differences between the method 500 and method 300 are described as below. When a main electronic device determines that there is no slave electronic device existed in the direction of a first baseline and a predetermined space using the direction of the first baseline as its own central line, the main electronic device still can determine the slave electronic device which is closest to the orientation of the main electronic device, by making a line connecting the main electronic device and the slave electronic device, which is closest to the orientation of the main electronic device, to be a second baseline and searching at least one target device along the second baseline. The details of the method 500 are as follows.

In step S507, when the main electronic device determines that there is no slave electronic device existed in the direction of the first baseline, the main electronic device determines whether any slave electronic devices exist in the predetermined space using the direction of the first baseline as the central line thereof. If there is at least one slave electronic device in the predetermined space, the flow goes to step S508, otherwise, the flow goes to step S509.

In step S508, when the main electronic device determines that there is at least one slave electronic device in the predetermined space using the direction of the first baseline as the central line thereof, the main electronic device selects the at least one slave electronic device in the predetermined space as at least one target device.

In step S509, the main electronic device determines whether any slave electronic devices exist in a second predetermined space using the second baseline as its own central line, wherein the second baseline is the line connecting the main electronic device and the slave electronic device closest to the orientation of the main electronic device. If there is at least one slave electronic device exists in the second predetermined space, the flow goes to step S510, otherwise, the flow goes to step S511.

In addition to determining whether any slave electronic devices exist in the second predetermined space using the direction of the second baseline as its own central line, the main electronic device can also determine whether any slave electronic devices exist in predetermined planes in the direction of the second baseline. When the main electronic device determines whether any slave electronic devices exist in the second predetermined space using the direction of the second baseline as its own central line, the main electronic device also filters other slave electronic devices. For example, the main electronic device performs filtering to the physical space in which other slave electronic devices exist, wherein the slave electronic device will be filtered out and will not be the target determined by the main electronic device when the slave electronic device experiences signal degradation, or when the slave electronic device is determined to be located in a different room according to an indoor map, for example.

In step S510, If the main electronic device determines that there is at least one slave electronic device that exists in the second predetermined space in the direction of the second baseline, the main electronic device selects the at least one slave electronic device, which is in the second predetermined space, as at least one target device, and perform step S512.

In step S511, if the main electronic device determines that there is no slave electronic device that exists in the second predetermined space in the direction of the second baseline, the main electronic device selects the slave electronic device which is closest to the orientation of the main electronic device as the target device, and performs step S512.

In step S512, the search and selection of at least one target device are finished.

In an embodiment, the main electronic device determines whether any slave electronic devices exist in the space which uses the direction of the second baseline y2 as its own central line and has a 45 degree expansion angle. The size of the second predetermined space is decided by multiple factors, and the factors include the supporting range of the main electronic device, setting of the search range, and the number and density of the slave electronic devices connected to the main electronic device, etc. Moreover, in other embodiments, the size of the second predetermined space is also determined based on the remaining power of the main electronic device. The more power that remains in the main electronic device A, the larger the second predetermined space is set. The less power that remains in the main electronic device A, the smaller the second predetermined space is set, in order to save power.

In step S510, the main electronic device selects at least one slave electronic device, which is in the second predetermined space in the direction of the second baseline, as at least one target device. In other embodiments, the main electronic device displays, on a display module, at least one slave electronic device in the second predetermined space using the direction of the second baseline as its own central line to the user of the main electronic device, which is for the user to select a part of (such as one, part of, or all of) the at least one slave electronic device in the second predetermined space using the direction of the second baseline as its own central line as at least one target device, and then the main electronic device can perform the controlling or data transmission in the following steps. The main electronic device selects the slave electronic device located in the direction of the second baseline as the target device, especially when there is no slave electronic device existed in the second predetermined space except in the direction of the second baseline.

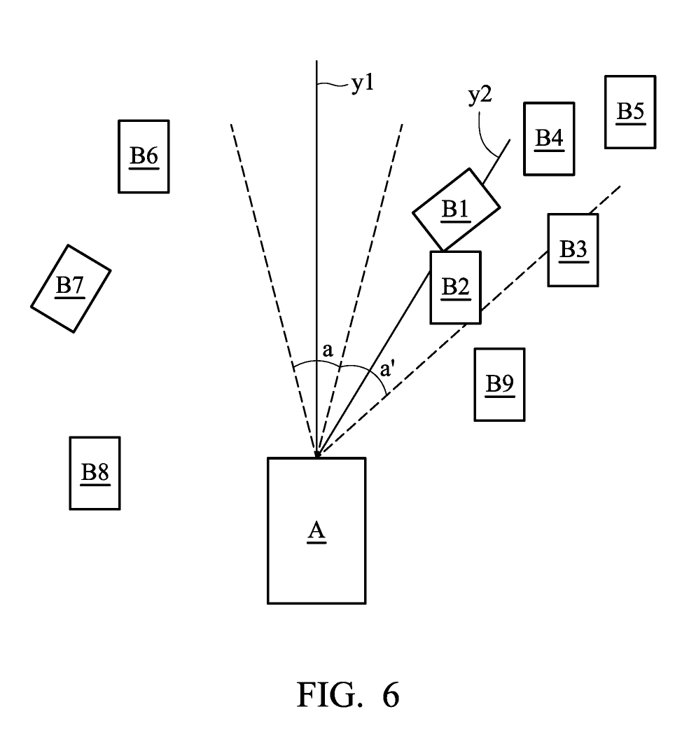

FIG. 6 shows a schematic diagram of the connection between a main electronic device A and slave electronic devices B1-B9 according to another embodiment of the present disclosure. As shown in FIG. 6, when the slave electronic devices B1-B5 exist in a second predetermined space a′ in a direction of a second baseline y2, the main electronic device A selects the slave electronic devices B1-B5 as target devices. Then the main electronic device A displays the slave electronic devices B1-B5, and the user can further select the target device according to actual need. For example, the main electronic device A informs the user that there is at least one slave electronic device in the second predetermined space a′ through the menu or voice report according to the distance or device type of the slave electronic devices B1-B6, which provides selections to the user, and the operation (sharing) described above is more accurate than the prior art.

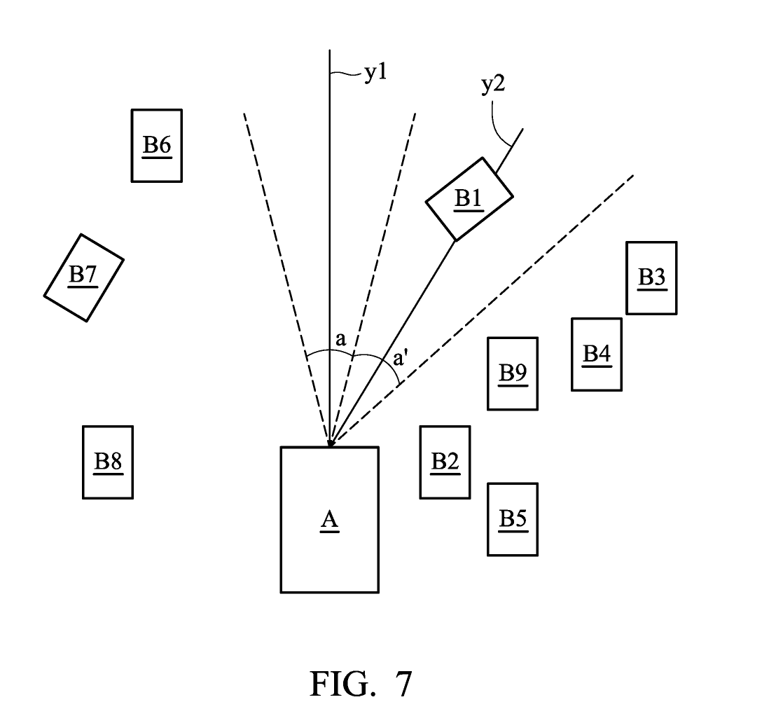

FIG. 7 shows a schematic diagram of the connection between a main electronic device A and slave electronic devices B1-B9 according to another embodiment of the present disclosure. As shown in FIG. 7, only the slave electronic device B1 exists in a second predetermined space a′ in a direction of a second baseline y2, and the slave electronic device B1 located in the direction of the second baseline y2 is selected as a target device.

After determining the slave electronic device as the target device of the main electronic device, the main electronic device performs data transmission with the slave electronic device. For example, the main electronic device shares the pictures, video, information or other data with the slave electronic device.

In this embodiment, the main electronic device may be a cellphone, a tablet, or a remote controller and so forth, and the slave electronic device may be a cellphone, a tablet, an air conditioner, a refrigerator, a television, a chandelier, or another smart home appliance. For example, based on the method for selecting the target device mentioned above, the user can enable the function of a cellphone and use the cellphone as a remote controller. After that, the user can turn to the chandelier of the room and click the power button on the remote controller. In this case, since there is only one chandelier in the predetermined space in the orientation of the cellphone, so the command of the power button operates directly on the chandelier and turns on the chandelier. Moreover, the user may then turn the cellphone toward an air conditioner and click the power button. In this case, since there is only one air conditioner in the predetermined space in the orientation of the cellphone, the air conditioner is turned on automatically. If there are multiple devices existed in the predetermined space in the orientation of the cellphone, such as an air conditioner, a refrigerator, and a television, these devices will be turned on at the same time, or the cellphone will prompt the user to make a selection from among these devices to through a menu or a voice report in order to let the user determine which device will perform the command.

The present invention can improve the versatility and efficiency of the user interface, and change the operation of different devices corresponding to the different interfaces to the operation of the different devices corresponding to the same interface. The operation of the device is determined by the orientation of the main device and the location of the slave electronic device, which makes the control an easy operation.

As mentioned in the description above, based on the present invention, the main electronic device can select the target device only by aligning the direction of the main electronic device with the slave electronic device, which makes the operation become fast, simple and easy, greatly improving user experience. Furthermore, the present invention can also improve the versatility and efficiency of the user interface, and change the operation of different devices corresponding to the different interfaces to the operation of the different devices corresponding to the same interface. The operation of the device is determined by the orientation of the main device and the location of the slave electronic device, which makes the control an easy operation.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of selecting at least one target device, applied to a main electronic device for selecting, from slave electronic devices connected to the main electronic device, at least one slave electronic device as the at least one target device, comprising:
obtaining main-device-location information of the main electronic device and slave-device-location information of the slave electronic devices;
determining an orientation of the main electronic device;
calculating, based on the main-device-location information and the slave-device-location information, relative location information of each slave electronic device corresponding to the main electronic device, respectively;
determining whether there is at least one electronic device in a direction of a first baseline according to the relative location information, wherein the direction of the first baseline is the orientation of the main electronic device; and
selecting the at least one slave electronic device as the at least one target device when the at least one slave electronic device exists in the direction of the first baseline.

2. The method of selecting at least one target device of claim 1, wherein the step of obtaining the main electronic device and slave-device-location information of the slave electronic devices further comprises:
sending, by the main electronic device, a query instruction to the slave electronic devices communicatively connected to the main electronic device; and
receiving the slave-device-location information from the slave electronic devices.

3. The method of selecting at least one target device of claim 1, wherein the step of obtaining the main electronic device and slave-device-location information of the slave electronic devices further comprises:
sending, by the main electronic device, a query instruction to a server communicatively connected to the main electronic device; and
receiving the slave-device-location information of the slave electronic devices from the server communicatively connected to the slave electronic devices.

4. The method of selecting at least one target device of claim 1, further comprising:
determining whether at least one slave electronic device exists in a predetermined space according to the relative location information when all of the slave electronic devices do not exist in the direction of the first baseline, wherein the first baseline is used as a central line of the predetermined space;
selecting, by the main electronic device, the at least one slave electronic device as the at least one target device when the at least one slave electronic device exists in the predetermined space.

5. The method of selecting at least one target device of claim 4, further comprising:
determining a first slave electronic device which is the closest one to the orientation of the main electronic device when the main electronic device determines that all of the slave electronic devices do not exist in the predetermined space;
making a second baseline, which connects the main electronic device and the first slave electronic device;
determining whether at least one slave electronic device exists in a second predetermined space whose central line is the second baseline; and
selecting the first slave electronic device as the at least one target device when all of the slave electronic devices do not exist in the second predetermined space.

6. The method of selecting at least one target device of claim 5, further comprising:
selecting a plurality of the slave electronic devices as the at least one target device when the plurality of the slave electronic devices exists in the second predetermined space.

7. The method of selecting at least one target device of claims 1, further comprising:
displaying, by the main electronic device, the at least one slave electronic device selected as the at least one target device.

8. The method for selecting at least one target device of claim 7, further comprising:
selecting, by a user of the main electronic device, at least one of the at least one slave electronic device, which is selected as the at least one target device, to perform a control operation.

9. The method of selecting at least one target device of claim 1, further comprising:
sending, by the main electronic device, data to the at least one slave electronic device which is selected as the at least one target device.

10. An electronic device, connected to slave electronic devices, supporting a method of selecting at least one target device, comprising:
a transceiver module, obtaining slave-device-location information of the slave electronic devices;
a locating module, obtaining main-device-location information of the electronic device through location technology;
an orientation module, determining an orientation of the electronic device;
a processor, coupled to the transceiver module, locating module, and orientation module, calculating relative location information of each slave electronic device corresponding to the electronic device based on the main-device-location information and the slave-device-location information, determining whether there is at least one slave electronic device in a direction of a first baseline according to the relative location information, wherein the direction of the first baseline is the orientation of the electronic device, and selecting at least one slave electronic device as the at least one target device when the at least one slave electronic device exists in the direction of the first baseline.

11. The electronic device of claim 10, wherein the orientation module comprises a compass, an acceleration sensor, or a gravity sensor.

12. The electronic device of claim 10, wherein the transceiver module further sending a query instruction to the slave electronic devices communicatively connected to the electronic device, and receiving the slave-device-location information from the slave electronic devices.

13. The electronic device of claim 10, wherein the transceiver module further sending a query instruction to a server communicatively connected to the electronic device, and receiving the slave-device-location information of the slave electronic devices from the server communicatively connected to the slave electronic devices.

14. The electronic device of claim 10, wherein the processor further determining whether at least one slave electronic device exists in a predetermined space according to the relative location information when the electronic device determines that all of the slave electronic devices do not exist in the direction of the first baseline, wherein the first baseline is used as a central line of the predetermined space; and
the processor further selecting the at least one slave electronic device as the at least one target device when the at least one slave electronic device exists in the predetermined space.

15. The electronic device of claim 10, wherein the processor determining whether at least one slave electronic device exists in a second predetermined space in a direction of a second baseline when the processor determines that all of the slave electronic devices do not exist in the predetermined space whose central line is the first baseline;
wherein the processor determines a first slave electronic device which is the closest one to the orientation of the electronic device, and makes a second baseline, which connects the electronic device and the first slave electronic device; and
the processor further selecting the first slave electronic device as the at least one target device when the electronic device determines that all of the slave electronic devices do not exist in the second predetermined space in the direction of the second baseline.

16. The electronic device of claim 15, wherein the processor further selects a plurality of the slave electronic devices as the at least one target device when the electronic device determines that the plurality of the slave electronic devices exists in the second predetermined space in the direction of the second baseline.

17. The electronic device of claim 10, further comprising:
a display module, displaying the at least one slave electronic device selected as the at least one target device.

18. The electronic device claim 10, wherein the transceiver module further sending data to the at least one slave electronic device selected as the at least one target device.

19. An electronic device, connected to a main electronic device, comprising:
a transceiver module, receiving a query instruction from the main electronic device;
a locating module, generating location information of the electronic device through location technology;
wherein the transceiver module further shares the location information of the electronic device to the main electronic device, which makes the main electronic device select at least one electronic device connected to the main electronic device as at least one target device according to the location information of the at least one electronic device and second location information of the main electronic device.

20. The electronic device of claim 19, wherein the transceiver module further receiving data information sent from the main electronic device to the electronic device after selecting the electronic device as the at least one target device by the main electronic device.

21. The electronic device of claim 19, wherein the transceiver module receiving a second query instruction from a server communicatively connected to the electronic device, and sends the location information of the electronic device to the server, wherein the server shares the location information of the electronic device to the main electronic device communicatively connected to the server.
